(19) United States
(12) Patent Application Publication
(10) Pub. No.: US 2018/0195341 A1
(43) Pub. Date: Jul. 12, 2018

(54) DOOR/JAMB REINFORCING KIT AND FRAME INTEGRATING SAME

(71) Applicant: Douglas Gudorf, Spring Valley, OH (US)

(72) Inventor: Douglas Gudorf, Spring Valley, OH (US)

(21) Appl. No.: 15/400,988

(22) Filed: Jan. 7, 2017

(51) Int. Cl. E06B 5/11; E05B 15/02; E05B 17/20; E05D 11/00

(52) U.S. Cl. CPC E06B 5/113; E05B 15/0205; E05Y 2900/132; E05D 11/0054; E05B 17/2084

(57) ABSTRACT

A reinforcing kit for a door having latching and locking mechanisms and door/jamb and frame having hinges therein includes a elongated door plates, elongated plates for doorjamb, hinge cover plates and reinforcing pins.

### BACKGROUND OF THE INVENTION

### 1. Field of Invention

The current invention relates to door jams. More particularly, the invention relates to a reinforcing kit for a doorjamb and frame integrating the same.

### 2. Prior Art

Most residential doors are comprised of wood or a composite of steel outer plate and wood core which are used in most residential construction. Such doors and door frames are prefabricated and are sold as a unit.

Such doors commonly include a primary door knob lock assembly, or lockset, and a deadbolt. The lockset latch bolt protrudes from the door into an appropriate opening in a strike plate. The strike plate is typically affixed to the doorjamb of the door casing by two screws. The deadbolt protrudes from the door into an appropriate opening in another strike plate attached to the door frame. These strike plates are commonly separate pieces. With only these conventional strike plates installed, it is relatively easy to break open a locked door by force, e.g., kicking the door in adjacent the door lock latch bolt and/or the deadbolt latch bolt breaking the doorjamb where the strike plates are located and allowing the door to be opened.

Recently, U.S. Pat. No. 8,904,713 described a mechanism addressing this concern. The invention used reinforcing plates applied to a doorjamb that is opposed by a door edge to strengthen the doorjamb to survive forced entry efforts. One plate has a protruding ramp configured to serve as a strike plate for a latch bolt mounted in the door and a bolt hole near the ramp. The second plate has an inner overlay and a perpendicular outer flange, forming an L-shaped cross-section. The reference mentions two prior U.S. Pat. Nos. 5,070,650 and 8,132,832 which show a strike plate with a doorjamb reinforcing system. These patents encountered problems with reinforcing both the door and the jamb is that adding either reinforcement of a conventional design narrows the small gap between the door and the jamb, so it was thought that it was not a practical solution as there was not sufficient room to add the reinforcement. In an effort to solve this, there were added opposing plates to the face of the door about the lock areas. This however, is less appealing to the owner and in any case does not offer the level of security desired. Accordingly, there remains a need to improve reinforcing doorjambs.

### SUMMARY OF INVENTION

It is an object to improve door safety.

It is an object to reinforce doors.

It is another object to reinforce doorjambs.

Still another object is to retrofit an existing door and jamb with a reinforcing kit of the instant invention.

In one embodiment, there is a reinforcing kit for a door having latching and locking mechanisms and doorjamb and frame having hinges thereon, which includes a first elongated plate (12, 12′) of resistant material, having a front face (14), a back (16), a plurality of pairs of counter sunk holes (18), each pair longitudinally spaced from other pair to allow the attachment of first elongated plate (12) to the door, the first elongated plate (12) having a door latch open surface (22) and a deadbolt open surface (24) longitudinally spaced from each other to allow the latching and locking mechanisms to pass through respective door latch open surface (22) and deadbolt open surface (24).

A second elongated plate (30) of resistant material is provided having a front face (32), a back (34), a plurality of pairs of counter sunk holes (36), each pair of counter sunk holes (36) longitudinally spaced from other pair of pair of counter sunk holes (36) to allow the attachment of the second elongated plate (30) to the doorjamb. The second elongated plate (30) including a door latch open surface (38) and a deadbolt open surface (40) longitudinally spaced from each other to allow the latching and locking mechanisms to pass through each respective open surface 38 and 40.

A hinge cover plate (50) of resistant material is provided having a front face (52), a back (54), a plurality of pairs of counter sunk holes (56). Each pair longitudinally i is spaced from other pairs 56, and holes (56) to allow the attachment of the hinge cover plate (50) to cover over the existing door hinge and to permit connection through hinge holes in the door hinge cover plate (50).

At least one pair of counter sunk holes (18) can preferably be between respective door latch open surface (22) and deadbolt open surface (24) and at least one pair of counter sunk holes (36) between respective door latch open surface (38) and deadbolt open surface (40). At least one reinforcing pin, and preferably several can be inserted into one or more edge an edge of the door. The pin(s) can be proximate one of the door latch and the door bolt.

### BRIEF DESCRIPTION OF THE SEVERAL VIEWS OF THE DRAWING

FIG. 1 is a perspective view of an embodiment of the invention installed on a door and in a door jamb of a door frame.

FIG. 2 is another perspective view of an embodiment of the invention of FIG. 1, showing.

FIG. 3 shows an enlarged detail portion of FIG. 2.

FIG. 4 is a top view of a door attached to a door frame having the invention connected thereto.

FIG. 5 is a section taken along line A-A in FIG. 4 through a part of the door.

FIG. 6 is another perspective view of an embodiment of the invention installed on a door.

FIG. 7 shows an enlarged detail portion of FIG. 6.

FIG. 8 is a top view of a door attached to a door frame having the invention connected thereto.

FIG. 9 is a section taken along line B-B in FIG. 8 through a part of the door.

FIG. 10 is an embodiment of a door jamb component of the invention.

FIG. 11 is an embodiment of a door component of the invention.

FIG. 12 is an embodiment of a hinge plate cover of the invention for a door jamb hinge.

FIG. 13 is an embodiment of a door jamb component of the invention.

FIG. 14 is an embodiment of a door component of the invention.

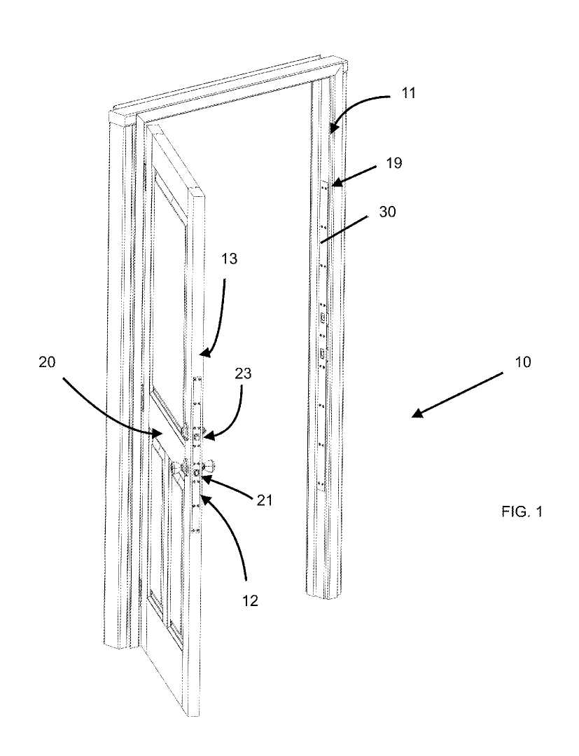

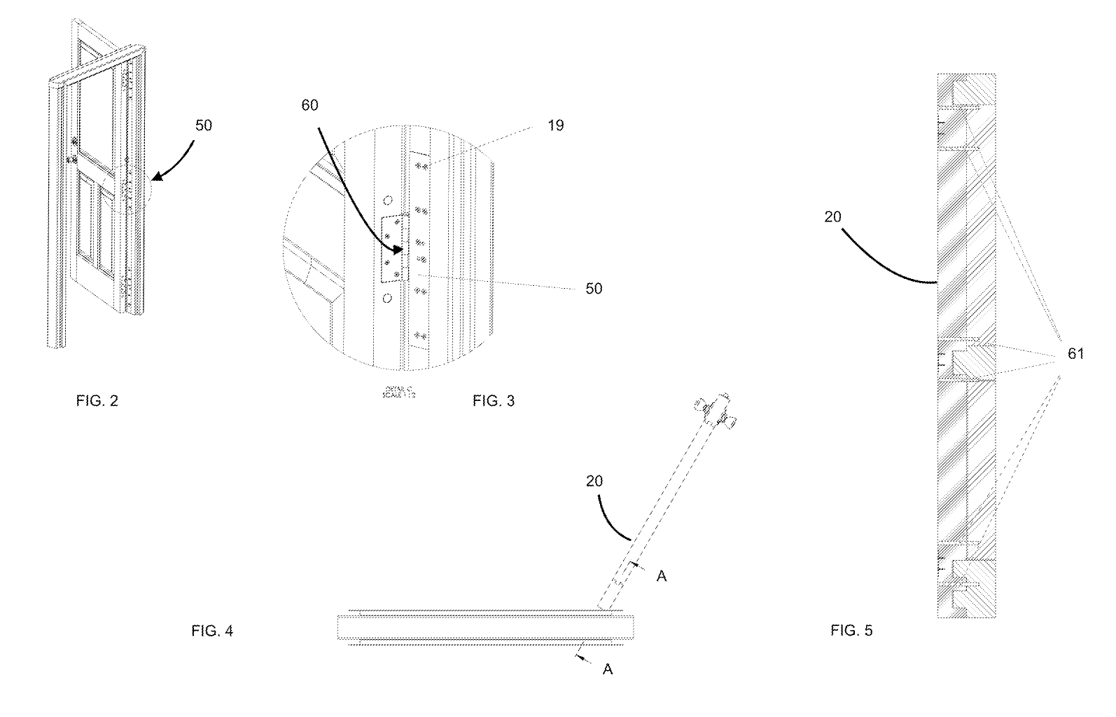

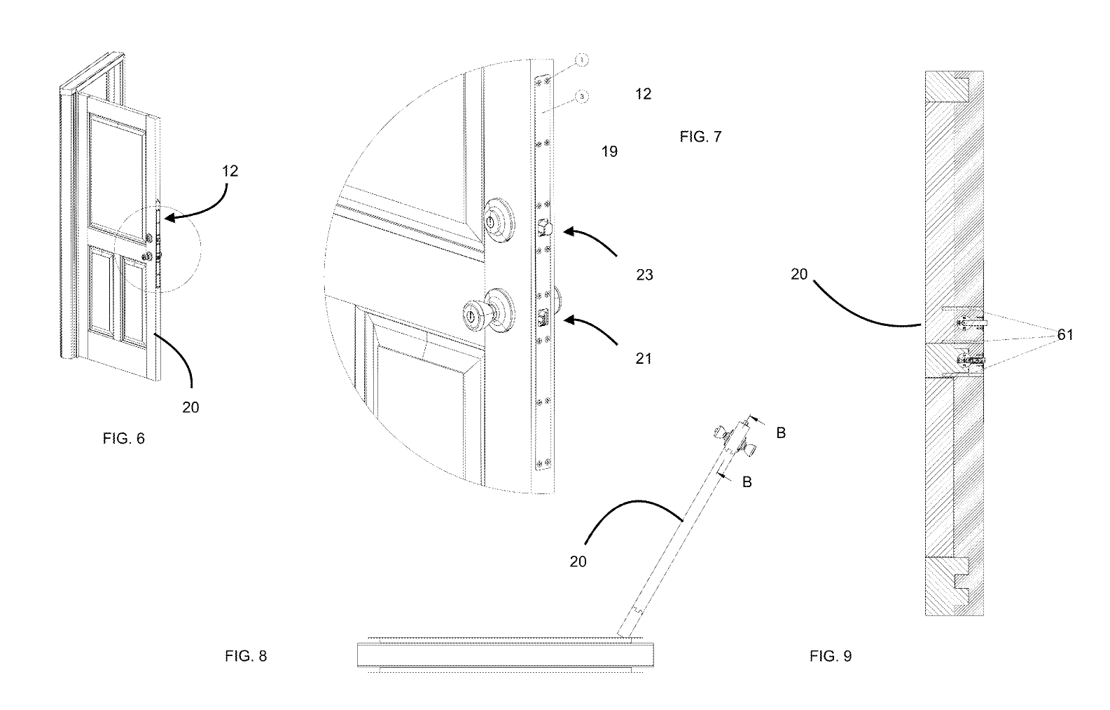

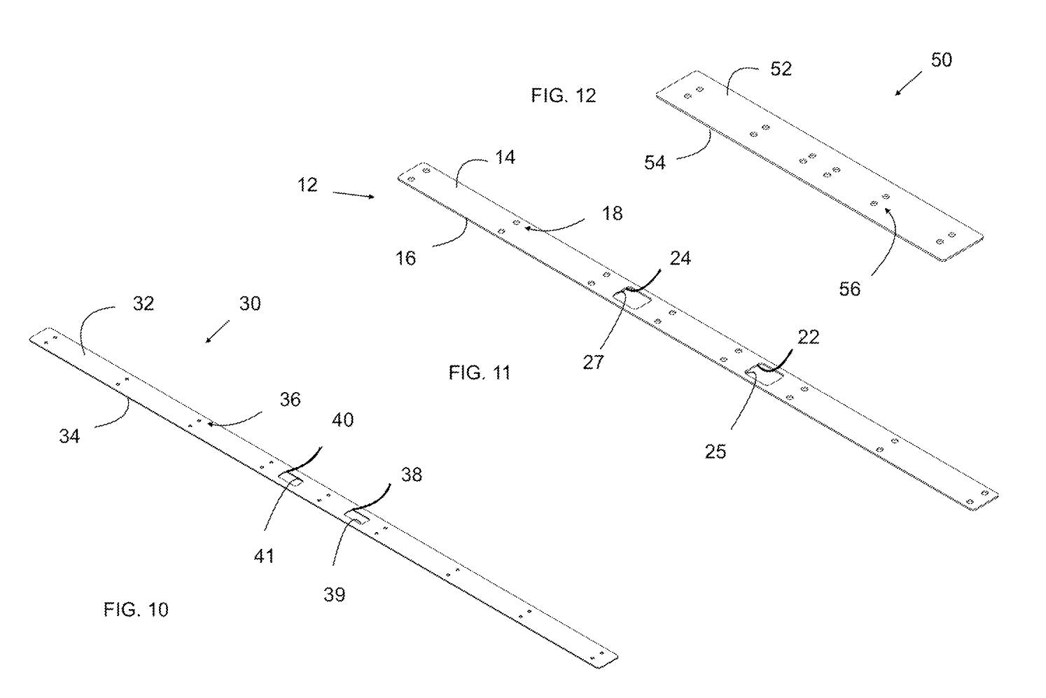

### DETAILED DESCRIPTION OF THE INVENTION

Referring now to the drawings, the reinforcing kit for a doorjamb and frame of a door integrating the same of the instant invention is generally designated by the numeral 10 for use with a door 20 and frame 11. The invention includes a first elongated plate 12 of resistant material, having front face 14, a back 16, a plurality of pairs of counter sunk holes 18, each pair longitudinally spaced from other pairs 18 to allow the attachment of the first elongated plate 12 to a door 20 and can be connected using threaded screws 19. The first elongated plate 12 can preferably have a minimum length of about 24 inches, a thickness of 0.06 inches and a width of about 1.3 inches. Additionally, there is a door latch open surface 22 and a deadbolt open surface 24 longitudinally spaced from each other to allow the latching and locking mechanisms to pass through each respective open surface 22 and 24. Open surfaces 22 and 24 are approximately 0.75 in in width and 1.6 in in length and include rounded inner corners 25 and 27, respectively, and can be offset about 5.5 inches on center. There is at least one pair of the counter sunk holes 18 between the open surfaces 22 and 24. In one embodiment, there are a plurality of spaced dead bolt open surfaces 24 which are longitudinally spaced from one another approximately 0.75 to several inches, for example.

The invention includes a second elongated plate 30 of resistant material, having a front face 32, a back 34, a plurality of pairs of counter sunk holes 36, each pair longitudinally spaced from other pairs 36 to allow the attachment of the second elongated plate 30 to a doorjamb 20. The elongated plate 30 can preferably have a minimum length of about 24 inches up to 48 inches, a thickness of 0.06 inches and a width of about 1.75 inches. Additionally, there is a door latch open surface 38 and a deadbolt open surface 40 longitudinally spaced from each other to allow the latching and locking mechanisms to pass through each respective open surface 38 and 40. Open surfaces 38 and 40 are approximately 0.75 in in width and 1.5 in in length and include rounded inner corners 39 and 41 respectively, and can be offset about 5.5 inches on center. There is at least one pair of the counter sunk holes 36 between the open surfaces 38 and 40. In one embodiment, there can be a plurality of spaced dead bolt open surfaces 40 which are longitudinally spaced from one another approximately 0.75 to several inches, for example.

Door latch open surface 22, 38 and a deadbolt open surface 24, 40 and are so configured for strength and minimal clearance with latch 21 and bolt 23. By so configuring, this provides for minimal movement during a forcible entry attempt.

The invention includes a third hinge cover plate 50 of resistant material, having a front face 52, a back 54, a plurality of pairs of counter sunk holes 56, each pair longitudinally spaced from other pairs 56, and including at least offset counter such holes 57 between the holes 56 to allow the attachment of the third hinge cover plate 50 to cover over an existing door hinge 60 and to permit connection through hinge holes therein. The third hinge cover plate 50 can preferably have a minimum length of about 12 inches, a thickness of 0.06 inches and a width of about 1.75 inches. The counter sunk holes 56 are configured to receive both left hand and right hand hinge connections.

The plates of the invention can be made by form 16 gauge ASTM, Steel of the appropriate length to shape it and create holes 6, 7 and fastening holes 8 as detailed in the preferred embodiment. Then, the door jamb enforcer is either coated with a desired color using powder-based paint or left uncoated.

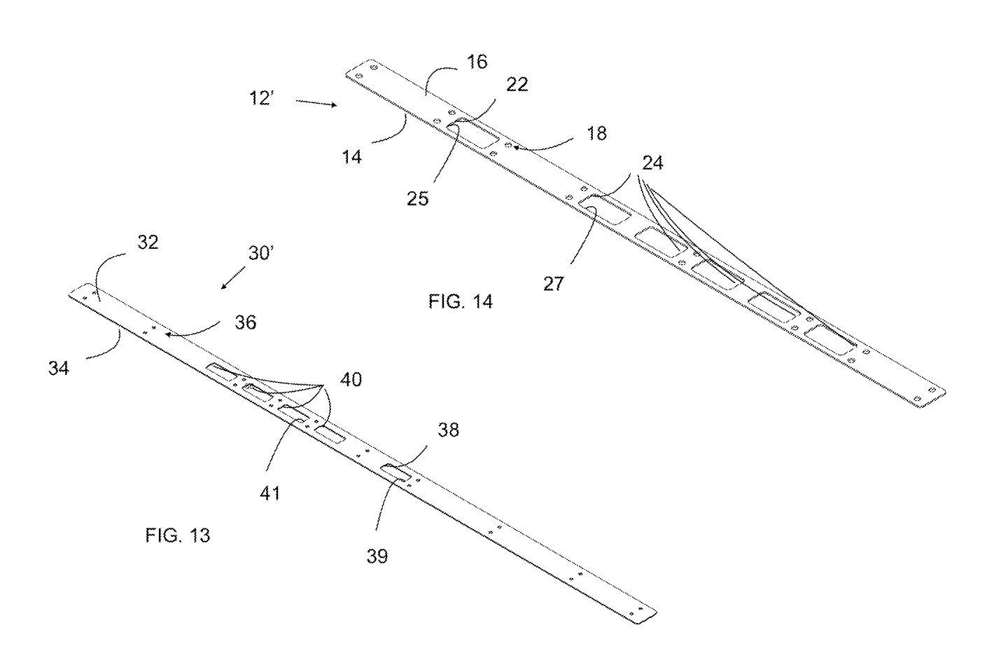

An alternative embodiment is seen in FIGS. 13 and 14. The embodiment is similar to that above and includes a first elongated plates 12′ and 30′ of resistant material. This plate has like numerals indicating like parts. A difference here is that there are plurality of pairs of open surfaces 24, 40 each longitudinally spaced from other to allow for variation in deadbolt spacing from the respective latch opening 22, 38.

There are additional reinforcing pins 61, preferably made of steel, which can be inserted or driven through a side edge of the door 20 preferable proximate about the latch 21 and bolt 23 to lend strength about these areas where the door 20 typically gives way. This is done prior to install of the elongated plate 12, 12′.

The instant invention is designed for use with door 20 which is made of wood or material which comprises wood or wood-like composite on its inner core. Unlike prior systems, the instant invention requires removal a thin layer of at least portion of outer edge 13 of the door 20 to form a cut out recess in the edge 13. In this way, the plate 12 is set in the recess of the edge 13 and is flush to permit the closing of the door 20. This is also aesthetically more appealing to in that the plate 20 remains hidden from front and back viewing when the door 20 is closed. In cases where the door frame 11 are made of material which typical comprises wood or wood-like composite material, depending on the gap which typically is provided between the door 20 and frame 11, it may be necessary to remove a thin layer of this material from portions of frame 11 to create recesses to accommodate plates 30 and 50.

Other modifications, derivations and improvements will be readily apparent to those skilled in the art. Accordingly, the appended claims hereto should be afforded the coverage of such modifications, derivations and improvements.

What is claimed is:

1. A reinforcing kit for a door having latching and locking mechanisms and doorjamb and frame having hinges thereon, which includes:
a first elongated plate (12) of resistant material, having a front face (14), a back (16), a plurality of pairs of counter sunk holes (18), each said pair longitudinally spaced from other said pair to allow the attachment of said first elongated plate (12) to the door, said first elongated plate (12) having a minimum length of about 24 inches, a thickness of up to about 0.06 inches and a width of up to about 1.3 inches, said first elongated plate having a door latch open surface (22) and a deadbolt open surface (24) longitudinally spaced from each other to allow the latching and locking mechanisms to pass through said respective door latch open surface (22) and said deadbolt open surface (24), said respective door latch open surface (22) and said deadbolt open surface (24) being approximately 0.75 inch in width and approximately 1.6 in in length and include rounded inner corners and having at least one pair of said counter sunk holes (18) between said respective door latch open surface (22) and said deadbolt open surface (24);
a second elongated plate (30) of resistant material, having a front face (32), a back (34), a plurality of pairs of counter sunk holes (36), each pair of said counter sunk holes (36) longitudinally spaced from said other pair of pair of counter sunk holes (36) to allow the attachment of said second elongated plate (30) to the doorjamb, said elongated plate (30) having a minimum length of about 24 inches, a thickness up to about 0.06 inches and a width up to about 1.75 inches, said second elongated plate (30) including a door latch open surface (38) and a deadbolt open surface (40) longitudinally spaced from each other to allow the latching and locking mechanisms to pass through said respective door latch open surface (38) and said deadbolt open surface (40), said respective door latch open surface (38) and said deadbolt open surface (40) are approximately 0.75 in in width and 1.5 in in length and include rounded inner corners (39) and (41), and at least one pair of said counter sunk holes (36) between the open surfaces (38) and (40); and
a hinge cover plate (50) of resistant material, having a front face (52), a back (54), a plurality of pairs of counter sunk holes (56), each pair longitudinally spaced from other pairs 56, and said holes (56) to allow the attachment of the hinge cover plate (50) to cover over the existing door hinge and to permit connection through hinge holes in the door hinge, said hinge cover plate (50) having a minimum length of about 12 inches, a thickness of up to about 0.06 inches and a width of up to about 1.75 inches.

2. The reinforcing kit of claim 1, wherein said first elongated plate includes a plurality of spaced dead bolt open surfaces 24 which are longitudinally spaced approximately 0.75 from one another.

3. The reinforcing kit of claim 1, which includes at least one reinforcing pin inserted into an edge of the door.

4. The reinforcing kit of claim 4, wherein said pin is proximate one of the door latch and the door bolt.

5. A reinforcing kit for a door having latching and locking mechanisms and doorjamb and frame having hinges thereon, which includes:
a first elongated plate (12, 12′) of resistant material, having a front face (14), a back (16), a plurality of pairs of counter sunk holes (18), each said pair longitudinally spaced from other said pair to allow the attachment of said first elongated plate (12) to the door, said first elongated plate (12), said first elongated plate having a door latch open surface (22) and a deadbolt open surface (24) longitudinally spaced from each other to allow the latching and locking mechanisms to pass through said respective door latch open surface (22) and said deadbolt open surface (24);
a second elongated plate (30) of resistant material, having a front face (32), a back (34), a plurality of pairs of counter sunk holes (36), each pair of said counter sunk holes (36) longitudinally spaced from said other pair of pair of counter sunk holes (36) to allow the attachment of said second elongated plate (30) to the doorjamb, said second elongated plate (30) including a door latch open surface (38) and a deadbolt open surface (40) longitudinally spaced from each other to allow the latching and locking mechanisms to pass through each respective latch open surface (38) and said deadbolt open surface (40); and
a hinge cover plate (50) of resistant material, having a front face (52), a back (54), a plurality of pairs of counter sunk holes (56), each pair longitudinally spaced from other pairs 56, and said holes (56) to allow the attachment of the hinge cover plate (50) to cover over the existing door hinge and to permit connection through hinge holes in the door hinge.

6. The reinforcing kit of claim 5, wherein at least one pair of said counter sunk holes (18) is between said respective door latch open surface (22) and said deadbolt open surface (24) at least one pair of said counter sunk holes (36) is between said respective door latch open surface (38) and said deadbolt open surface (40).

7. The reinforcing kit of claim 5, wherein said first elongated plate includes a plurality of spaced dead bolt open surfaces (24) which are longitudinally spaced approximately 0.75 from one another and a plurality of spaced dead bolt open surfaces (40) which are longitudinally spaced approximately 0.75 from one another.

8. The reinforcing kit of claim 5, which includes at least one reinforcing pin inserted into an edge of the door.

9. The reinforcing kit of claim 6, wherein said pin is proximate one of the door latch and the door bolt.

10. A reinforcing kit for a door having latching and locking mechanisms and doorjamb and frame having hinges thereon, which includes:
a first elongated plate (12, 12′) of resistant material, having a front face (14), a back (16), a plurality of longitudinally spaced counter sunk holes (18) to allow the attachment of said first elongated plate (12) to the door, said first elongated plate (12), said first elongated plate having a door latch open surface (22) and a deadbolt open surface (24) longitudinally spaced from each other to allow the latching and locking mechanisms to pass through said respective door latch open surface (22) and said deadbolt open surface (24);
a second elongated plate (30) of resistant material, having a front face (32), a back (34), a plurality of longitudinally spaced counter sunk holes (36), to allow the attachment of said second elongated plate (30) to the doorjamb, said second elongated plate (30) including a door latch open surface (38) and a deadbolt open surface (40) longitudinally spaced from each other to allow the latching and locking mechanisms to pass through each respective latch open surface (38) and said deadbolt open surface (40);
a hinge cover plate (50) of resistant material, having a front face (52), a back (54), a plurality of longitudinally spaced counter sunk holes (56), and said holes (56) to allow the attachment of the hinge cover plate (50) to cover over the existing door hinge and to permit connection through hinge holes in the door hinge; and at least one reinforcing pin inserted into an edge of the door.

11. The reinforcing kit of claim 10, wherein said pin is proximate one of the door latch and the door bolt.

12. A reinforcing kit for a door having latching and locking mechanisms and doorjamb and frame having hinges thereon, which includes:
a door having an outer edge configured and receives thereon a first elongated plate (12, 12′) of resistant material, having a front face (14), a back (16), a plurality of longitudinally spaced counter sunk holes (18) to allow the attachment of said first elongated plate (12) to the door, said first elongated plate (12), said first elongated plate having a door latch open surface (22) and a deadbolt open surface (24) longitudinally spaced from each other to allow the latching and locking mechanisms to pass through said respective door latch open surface (22) and said deadbolt open surface (24);
a doorjamb having an inner edge configured and receives thereon a second elongated plate (30) of resistant material, having a front face (32), a back (34), a plurality of longitudinally spaced counter sunk holes (36), to allow the attachment of said second elongated plate (30) to the doorjamb, said second elongated plate (30) including a door latch open surface (38) and a deadbolt open surface (40) longitudinally spaced from each other to allow the latching and locking mechanisms to pass through each respective latch open surface (38) and said deadbolt open surface (40); and
the doorjamb having another inner edge configured and receives thereon a hinge cover plate (50) of resistant material, having a front face (52), a back (54), a plurality of longitudinally spaced counter sunk holes (56), and said holes (56) to allow the attachment of the hinge cover plate (50) to cover over the existing door hinge and to permit connection through hinge holes in the door hinge and connection to the doorjamb.

13. The reinforcing kit for a door having latching and locking mechanisms and doorjamb and frame of claim 12, having at least one reinforcing pin inserted into an edge of the door.

14. The reinforcing kit of claim 13, wherein said pin is proximate one of the door latch and the door bolt.
